(19) United States
(12) Patent Application Publication
(10) Pub. No.: US 2015/0338227 A1
(43) Pub. Date: Nov. 26, 2015

(54) NAVIGATION SYSTEM

(71) Applicant: JOACHIM KRUECKEN, MUNICH (DE)

(72) Inventor: JOACHIM KRUECKEN, MUNICH (DE)

(73) Assignee: Freescale Semiconductor, Inc., Austin, TX (US)

(21) Appl. No.: 14/436,768

(22) PCT Filed: Nov. 22, 2012
(86) PCT No.: PCT/IB2012/056636

§ 371 Date: Apr. 17, 2015

(51) Int. Cl. G01C 21/36; G01S 19/13; G06F 17/30

(52) U.S. Cl. CPC G01C 21/3605; G06F 17/30241; G01S 19/13

(57) ABSTRACT

An electronic device is for providing navigation information for a driver of a vehicle. The device has a location unit for determining geographical location data based on satellite signals, a navigation processor coupled to at least one sensor comprising a sound sensor. The navigation processor is arranged for obtaining destination data, determining route data based on the geographical location data, the destination data and map data. The navigation information is calculated based on the route data. Subsequently, navigation assistance information is generated related to the route information and based on sound data as detected via the sound sensor. Advantageously, by using environmental sound, the navigation may be improved, because additional data and corrections of driver activity can be early generated based on the sound data.

### FIELD OF THE INVENTION

This invention relates to electronic devices for navigation, for example car navigation.

More specifically, the invention is in the field of.

### BACKGROUND OF THE INVENTION

United States patent application US 2012/0259539 describes a navigation device that includes a processing unit, a display, a storage unit, a voice input/output unit (including a microphone as a voice input unit and a speaker as a voice output unit), a vehicle speed sensor, a gyro sensor, a global positioning system (GPS) receiver. Furthermore a camera and an in-vehicle network communication unit may be coupled to the device.

The processing unit is a central unit which performs various kinds of processing. For example, the processing unit calculates the present location based on information output by, for example, the vehicle speed and the gyro sensors, the GPS receiver, and the like. Further, based on the obtained information on the present location, the processing unit reads out map data necessary to be displayed, from the storage unit.

Still further, the processing unit graphically develops the map data thus read out, and displays the map data thus developed with a mark indicating the present location superimposed thereon, on the display. The processing unit also makes a search for a route which connects a departure place (present location) and a destination (or via point or stop-off point), which are designated by the user, by using the map data or the like stored in the storage unit. In addition, the processing unit provides the user with guidance by using the speaker and the display.

A problem of the above navigation system is that the system provides navigation information to the user regarding the route, which navigation information is only based on the route and/or actual vehicle location.

### SUMMARY OF THE INVENTION

The present invention provides an electronic device, and a method, as described in the accompanying claims.

Specific embodiments of the invention are set forth in the dependent claims. Aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings.

FIG. 1 shows an example of an electronic device for providing navigation information for a driver of a vehicle, and

FIG. 2 shows an example of a process for providing additional navigation data.

Elements in the figures are illustrated for simplicity and clarity and have not necessarily been drawn to scale. In the Figures, elements which correspond to elements already described may have the same reference numerals.

### DETAILED DESCRIPTION OF THE PREFERRED EMBODIMENTS

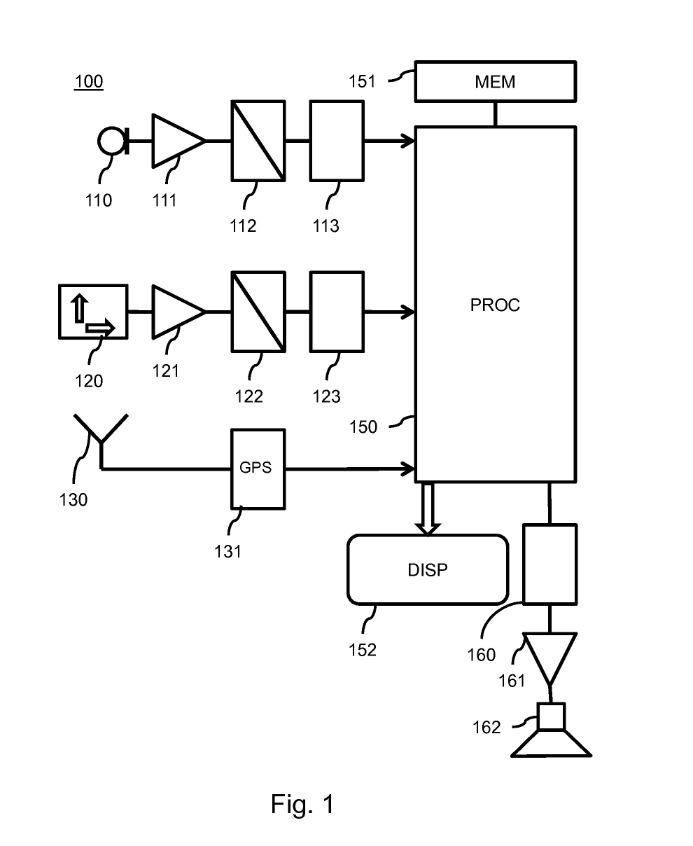

FIG. 1 shows an example of an electronic device for providing navigation information for a driver of a vehicle. The device 100 has a navigation processor 150 coupled to a memory 151, a display 152 and a sound output arrangement, for example having a sound generation unit 160, an amplifier 161, and a loudspeaker 162. The device 100 has a location unit 131 for determining geographical location data based on satellite signals, for example the well known GPS signals of the Global Positioning System. The location unit is coupled to an antenna 130 for receiving the satellite signals. The geographical location data, e.g. coordinates on a map, are coupled to the navigation processor 150. The navigation processor 150 is further arranged to be coupled to at least one sensor for acquiring environmental data from the environment of the electronic device. A sound sensor 110, for example a microphone, may be coupled to an amplifier 111, an analog to digital convertor 112 to provide sound data to the navigation processor. The sound sensor may be connected to a sound recognition unit 113 for recognizing one or more specific predetermined sound events. The output of the sound recognition unit is coupled to the navigation processor.

An acceleration sensor 120, for example an accelerometer or a gyro, may be coupled to an amplifier 121, an analog to digital convertor 122 to provide acceleration data to the navigation processor. The acceleration sensor may be connected to an acceleration processing unit 123 for processing acceleration signals, e.g. recognizing one or more specific predetermined acceleration events, or limiting the acceleration signals. The output of the acceleration processing unit is coupled to the navigation processor.

The various electronic circuits for implementing the above units may be suitably integrated in a semiconductor device, usually called an IC, or may be implemented using various ICs and/or further electronic components. The device may further have, in a suitable casing, the at least one sensor, including a sound sensor 110 and possible further sensors, such as a temperature sensor for acquiring further environmental data from the environment of the electronic device. Also, the device may have, in said casing, a user interface for interacting with a user and rendering the navigation information and the navigation assistance information. For example, the device may be a self-contained navigation device, or a mobile phone provided with navigation application software, for example a so-called app, the software including the functions of the navigation processor and/or processing the sensor signals, such as sound recognition.

The navigation processor 150 is arranged for obtaining destination data and determining route data based on the geographical location data, the destination data and map data. The map data may be stored in the memory, and/or may be obtained as require from a remote database, e.g. via the internet. Subsequently, the navigation processor is arranged for calculating the navigation information based on the route data. In particular, the navigation processor generates navigation assistance information related to the route information and based on sound data as detected via the sound sensor, as described now.

The sound data is detected as follows. Via the sound sensor the sound in the vehicle is received, and the sound signal is processed to determine specific sounds. For example, the sound may be processed to detect the sound of a turn indicator, or the sound of a crash, or the sound of an ambulance near the vehicle. Subsequently, the navigation processor may generate additional data to be communicated to the driver, or to a further destination such as an emergency service or the police, in dependence of the sound event detected. For example, the driver may get ill and/or may scream for help or an urgent stop. The system may generate additional navigation instructions, and/or communicate with an external service, e.g. adapt the route data if an emergency is detected, or warn the police if a crash sound is detected.

The navigation assistance information is further information that supports or enhances the navigation information. For example, the navigation assistance information may be repeating the last navigation instruction when the navigation processor detects, via the sound sensor, that the vehicle is not preparing for executing the last instruction. Alternatively, a further navigation instruction may be generated when the navigation processor detects, via the sound sensor, that the vehicle is preparing taking a wrong right or left turn, whereas in accordance with the route data, no turn or a different is foreseen. The further instruction may be a warning that no turn is planned in the route.

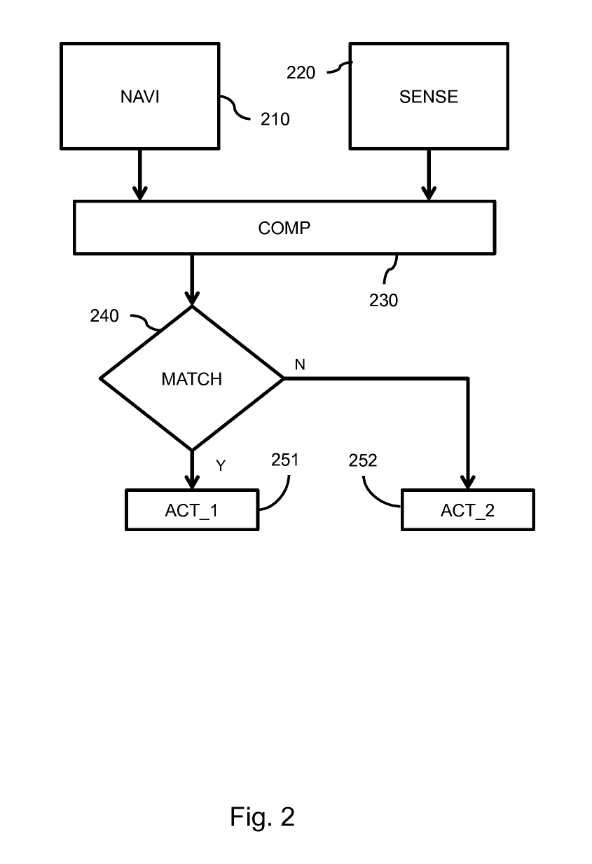

FIG. 2 shows an example of a process for providing additional navigation data. In a navigation process NAVI 210 route data is generated, also called a navigation scenario which includes a route and possible further data according to geographical location data, destination data and map data. In the NAVI process, the geographical location data is determined based on satellite signals, and the route data is determined based on the geographical location data, the destination data and map data. Finally, the navigation information is calculated based on the route data.

In a sensor process SENSE 220, sensor signal of one or more sensors are processed to generate environmental situation data. For example, from a microphone sound sensor, one or more sound patterns are detected. The respective sound patterns are determined to be representative of a respective situation in the vehicle. For example, a sound may be detected corresponding to an audible turn indicator (click-clack), and the corresponding situation may be that the driver intends to take a turn. Multiple different situations may be detected in dependence of various sensor signal patterns. For example, an acceleration sensor signal having a pattern of strong deceleration in combination with a sound level indicative of an impact of the car on a further object, may be estimated to be indicative of a crash.

Both the output of the NAVI process and the SENSE process are transferred to a comparison process COMP 230. In the comparison process it is determined whether a detected environmental situation corresponds to the navigation information. It is noted that some situations are clearly to be expected, e.g. in a car, after the navigation information of an upcoming turn has been displayed for the driver, the driver is expected to activate the turn indicator. If so the predicted situation based on the navigation scenario corresponds to the actual environmental situation from the SENSE process, which matching operation is indicated in the Figure by process MATCH 240.

In the process MATCH, if a match has been detected between a predicted situation based on the navigation information and an actual environmental situation as detected, the MATCH process may trigger one or more actions. In the FIG. 2, a first action ACT_1 251 is triggered when a match is detected between a predicted situation and an actual environmental situation, e.g. when a turn indicator is detected and a turn is upcoming in the route data. A second action ACT_2 252 is triggered when no match is detected between a predicted situation and an actual environmental situation, e.g. a turn is upcoming in the route data, but no turn indicator sound pattern is found, or a crash situation is detected.

Hence, in the process of FIG. 2, a navigation scenario as determined in NAVI is compared by COMP to environmental data is detected by SENSE via at least one sensor including a sound sensor, from the environment of the electronic device. NAVI has obtained destination data, geographical data and map data and determines a route. Based on the comparison MATCH generates navigation assistance information related to the route information based on sound as detected via the sound sensor. The process may be implemented in software, e.g. an app for a mobile phone or tablet, or in a program memory of a dedicated navigation device.

Optionally, in the method, a sound indicative of a vehicle movement as intended by a driver of the vehicle is determined. Said generating of the navigation assistance information may comprise recognizing a sound of a turn indicator in the vehicle.

Optionally, the method may comprise sound learning, in which the predetermined sound is to be activated for enabling the recognition unit to detect and store sound data for recognizing the predetermined sound. Further option are described for the navigation processor, but may alternatively be implemented in the method. Also, the above methods may be implemented in software, either dedicated for a particular device or more general as an application (APP) for a predetermined type of mobile phone or tablet.

Optionally, in the above device, the navigation processor is arranged for generating the navigation assistance information in dependence of determining sound data indicative of a vehicle movement as intended by the driver. For example, a sound may be detected of a turn indicator. Furthermore, from said sound, a spoken phrase may be recognized indicative of a vehicle movement as intended by the driver of the vehicle. For example a person sitting next to the driver may say: “you have to turn left”, whereas the route data and navigation information have an upcoming turn to the right. If so, the navigation assistance information may be produced as a warning that there is possibly an error in the voiced instruction.

Optionally, in the device, the navigation processor is arranged for generating the navigation assistance information in dependence of determining a deviation between the sound data and predicted environmental sound as predicted according to regular environmental conditions. The navigation scenario may for example predict a particular sound according to regular environmental conditions, such as a motor sound of decreasing speed and possibly gear shift while preparing for taking a turn which is required according to the route. However, when the motor sound does not change, said deviation is determined. Subsequently, a warning may be generated as navigation assistance information, e.g. “your speed is too high for the upcoming turn”.

Optionally, in the device, the navigation processor has a sound recognition unit and is arranged for said generating in dependence of a predetermined sound as recognized. As such, sound recognition and/or voice recognition are well known signal processing techniques. Speech recognition is well developed as such, and a basic recognition of a sound (e.g. by duration, frequency and repetition rate), is much easier. For example, a set of predetermined sound patterns may be stored in a memory, and the incoming sound may be correlated with each of the patterns. In an embodiment, the sound recognition unit is arranged for recognizing a sound of a turn indicator. Subsequently, the navigation processor may be arranged for adapting the navigation information in dependence of the presence or absence of the sound of the turn indicator.

Optionally, in the device, the navigation processor has a sound learning mode. The learning mode may be activated on installation of the device in a car, or at first use, or on request of the user, or when, in practice, too many errors in recognizing of the sound events occur. In the learning mode the predetermined sound is to be activated or produced, e.g. by the user switching on the turn indicator at standstill or during a test drive. Now the user activates an acquisition phase in the learning process, so as to enable the recognition unit to detect and store sound data for recognizing the predetermined sound.

Optionally, in the device, the at least one sensor comprises an acceleration sensor 120, and further interfacing elements 121,122, as shown in FIG. 1. The navigation processor has an acceleration unit 123 for detecting a movement of the device, for example a turn or a deceleration. The navigation processor is arranged for said generating the navigation assistance information in dependence of movement as detected. For example, when a sharp turn of well over 90 degrees into a small street is upcoming, the acceleration unit may detect a high vehicle speed, which is too high for said turn. A warning may be generated.

Optionally, in the device, the acceleration unit is arranged for detecting a predicted turn movement of a motorized vehicle. The turn movement is predicted based on the route data and navigation instructions in the navigation information. For example the acceleration unit detects that the driver, when approaching a crossing, takes the left lane. However, the route requires selecting the right line, because a right turn will follow. A warning may be generated as navigation assistance information. Furthermore, the navigation processor may be arranged for adapting the navigation information in dependence of the presence or absence of the predetermined turn movement. For example, an alternative route may be prepared when a left lane is picked in the preceding example.

Optionally, in the device, the navigation processor is arranged for generating a crash alarm signal based on a crash movement as detected by said acceleration unit. A crash will unavoidably cause a very strong deceleration or acceleration, e.g. when another vehicle hits a car from the back at high speed.

Optionally, the navigation processor is arranged for generating a crash alarm signal based on a crash sound as recognized. The crash sound may be detecting sound level above a predetermined level, and a sharp increase of a sound pulse. Also a sound of having breaking, such as shrieking tires, may be detected. Furthermore, the navigation processor may be arranged for generating the crash alarm signal based both on a crash sound as recognized in combination with a crash movement as detected. The combined occurrence and detection of signals makes the crash alarm more reliable.

Optionally, in the device, the navigation processor is arranged for adapting the navigation information in dependence of the crash alarm signal. For example, a route to the nearest doctor, hospital or first aid station may be proposed to the driver.

Optionally, in the device, the navigation processor is arranged for transferring the crash alarm signal via a communication network. For example, the crash alarm signal may be forwarded to a police station via a mobile telephone network or the internet. The navigation processor may further arranged for transferring, in addition to the crash alarm signal, the geographical location data and/or route data. For example, the police station may immediately be informed about the location of the device, i.e. the vehicle in which the device is present.

It is noted that many car drivers use navigation systems or smartphones as standalone devices for car navigation, which are not connected to the car. Therefore, those systems cannot tap any data sent over a car network like speed and turn indicators. A special wire to the car bus systems is not attractive given the location of those navigation systems and the extra cost it incurs. On the contrary, the above described system may improve the capabilities of add-on navigation systems, tablets or mobile phones running a navigation application at limited extra cost.

Via the status of the turn-indicator, the current navigation system gets information about the intention of the driver, and is enabled to adjust text messages or display accordingly. Per law the turn-indicator must not only display a blinking green light but also provide a well defined audible feedback (click/clack). Given the fact that most of the navigation systems, tablets and smartphones have a microphone a sound recognition system is provided for filtering out the sound data. Furthermore, the device may have an accelerometer. Using the accelerometer in conjunction with a sound recognition could detect crashes and make an emergency call.

In the foregoing description, the invention has been described with reference to specific examples of embodiments of the invention. It will, however, be evident that various modifications and changes may be made therein without departing from the broader spirit and scope of the invention as set forth in the appended claims. For example, the connections may be any type of connection suitable to transfer signals from or to the respective nodes, units or devices, for example via intermediate devices. Accordingly, unless implied or stated otherwise the connections may for example be direct connections or indirect connections.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Although the invention has been described with respect to specific conductivity types or polarity of potentials, skilled artisans appreciated that conductivity types and polarities of potentials may be reversed.

Also, the invention is not limited to physical devices or units implemented in non-programmable hardware but can also be applied in programmable devices, such as a FPGA (Field Programmable Gate Array) or processor units able to perform the desired device functions by operating in accordance with suitable program code, e.g. so-called firmware or software. The FPGA is an integrated circuit designed to be configured by a customer or a designer after manufacturing, so-called “field-programmable”. The FPGA configuration is generally specified using a hardware description language (HDL). Furthermore, the device may be physically distributed over a number of apparatuses, while functionally operating as a single device.

Furthermore, the units and circuits may be suitably combined in one or more semiconductor devices.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A electronic device for providing navigation information for a driver of a vehicle, the device comprising:
a location unit for determining geographical location data based on satellite signals;
at least one sensor configured to acquire environmental data from the environment of the electronic device, wherein the at least one sensor comprises a sound sensor;
a navigation processor, coupled to the at least one sensor and the location unit, wherein the navigation processor is arranged for
obtaining destination data,
determining route data based on the geographical location data, the destination data and map data,
calculating the navigation information based on the route data, and
generating navigation assistance information related to the route information and based on sound data as detected via the sound sensor.

2. The device as claimed in claim 1, wherein the navigation processor is arranged for said generating navigation assistance information in dependence of
determining sound data indicative of a vehicle movement as intended by the driver.

3. The device as claimed in claim 1, wherein the navigation processor is arranged for said generating navigation assistance information in dependence of
determining a deviation between the sound data and predicted environmental sound as predicted according to regular environmental conditions.

4. The device as claimed in claim 1, wherein the navigation processor comprises a sound recognition unit and is arranged for said generating navigation assistance information in dependence of a predetermined sound as recognized by the sound recognition unit.

5. The device as claimed in claim 4, wherein the sound recognition unit is arranged for recognizing a sound of a turn indicator.

6. The device as claimed in claim 5, wherein the navigation processor is arranged for adapting the navigation information in dependence of the presence or absence of the sound of the turn indicator.

7. The device as claimed in claim 4, wherein the navigation processor is configured to provide a sound learning mode, in which mode the predetermined sound is to be activated for enabling the recognition unit to detect and store sound data for recognizing the predetermined sound.

8. The device as claimed in claim 1, wherein
the at least one sensor further comprises an acceleration sensor, and
the navigation processor comprises an acceleration unit configured to detect a movement of the device based on signals from the acceleration sensor and is arranged for said generating navigation assistance in dependence of the detected movement.

9. The device as claimed in the claims 8, wherein the navigation processor is arranged for generating a crash alarm signal in response to a detected crash movement by the acceleration sensor.

10. The device as claimed in the claims 8, wherein the navigation processor is arranged for generating a crash alarm signal in response to a recognized crash sound in combination with a detected crash movement by the acceleration sensor.

11. The device as claimed in the claim 1, wherein the navigation processor is arranged for generating a crash alarm signal in response to a recognized crash sound.

12. The device as claimed in claim 9, wherein the navigation processor is arranged for adapting the navigation information in dependence of the crash alarm signal.

13. The device as claimed in claim 9, wherein the navigation processor is arranged for transferring the crash alarm signal via a communication network.

14. The device as claimed in claim 13, wherein the navigation processor is arranged for transferring, in addition to the crash alarm signal, one or more of the geographical location data and the route data.

15. An integrated circuit comprising the electronic device according to claim 1.

16. The device as claimed in claim 1, further comprising
a user interface for interacting with a user and rendering the navigation information and the navigation assistance information.

17. A method of providing navigation information for a driver of a vehicle, the method comprising
determining geographical location data based on satellite signals;
acquiring environmental data from the environment of an electronic device comprising a sound sensor configured to perform said acquiring;
obtaining destination data;
determining route data based on one or more of the geographical location data, the destination data and map data;
calculating the navigation information based on the route data; and
generating navigation assistance information related to the route information and based on sound as detected via the sound sensor.

18. The method as claimed in claim 17, wherein said generating comprises
determining a sound indicative of a vehicle movement as intended by a driver of the vehicle.

19. The method as claimed in claim 17, wherein said generating comprises recognizing a sound of a turn indicator in the vehicle.

20. The method as claimed in claim 18, wherein the method comprises sound learning, in which the predetermined sound is to be activated for enabling the recognition unit to detect and store sound data for recognizing the predetermined sound.
